(19) United States
(12) Patent Application Publication
(10) Pub. No.: US 2023/0008516 A1
(43) Pub. Date: Jan. 12, 2023

(54) ANTIFOULANT COMPOSITION AND METHOD FOR A NATURAL GAS PROCESSING PLANT

(71) Applicant: BL TECHNOLOGIES, INC., MINNETONKA, MN (US)

(72) Inventors: Guangzhe YU, Minnetonka, MN (US); Eric LE, Minnetonka, MN (US); Tony FIELDS, Minnetonka, MN (US)

(21) Appl. No.: 17/784,990

(22) PCT Filed: Sep. 15, 2020
(86) PCT No.: PCT/US2020/050815

§ 371 Date: Jun. 13, 2022

Related U.S. Application Data
(60) Provisional application No. 62/948,216, filed on Dec. 14, 2019.

(51) Int. Cl. C09K 8/524; C10G 75/04

(52) U.S. Cl. CPC C09K 8/524; C10G 75/04; C10G 2300/4075

(57) ABSTRACT

An antifoulant composition for a gas processing plant, the composition having a phosphonothioic ester; a non-ionic surfactant; and a film forming surfactant. A method for inhibiting fouling in a gas processing plant, the method (a) providing an antifoulant composition; and (b) adding the antifoulant composition to a hydrocarbon stream present in a gas processing plant.

### CROSS REFERENCE TO RELATED APPLICATION

This application claims the priority benefit of U.S. Provisional Patent Application Ser. No. 62/948,216 filed Dec. 14, 2019, the entirety of which is incorporated herein by reference.

### FIELD OF INVENTION

The disclosed technology generally provides for an antifoulant composition and method, and more specifically, an antifoulant composition and method for treating hydrocarbon streams during natural gas processing.

### BACKGROUND OF THE INVENTION

Generally, gas processing plants separate impurities and non-methane hydrocarbons from raw natural gas. Methane hydrocarbons are used primarily as fuels, namely natural gas. Non-methane hydrocarbon streams are commonly in the form of condensates, which consist primarily of C2-C5 hydrocarbons.

Processing of such hydrocarbon streams involves many different processes, in which heating, boiling and condensing of hydrocarbons are performed to help with separation and purification. During processes where heating and boiling occurs (for example, in heat exchangers and reboilers), fouling of unwanted deposits develop on the equipment surfaces and piping systems. Such fouling causes increased fuel consumption, loss of throughput, increased downtime, and/or safety concerns.

Thus, what is needed in the art is a composition and method for inhibiting fouling in natural gas processing plants.

### SUMMARY OF THE INVENTION

The disclosed technology generally provides for an antifoulant composition and method, and more specifically, an antifoulant composition and method for treating hydrocarbon streams during natural gas processing.

In one aspect of the disclosed technology, an antifoulant composition for inhibiting fouling comprises a phosphonothioic ester. In some embodiments, the phosphonothioic ester is a phosphonothioic polyalkenyl ester. In some embodiments, the phosphonothioic polyalkenyl ester is a phosphonothioic polyisobutenyl ester.

In some embodiments, the antifoulant composition further comprises an alkyl succinimide, a detergent, and/or an asphaltene dispersant. In some embodiments, the antifoulant composition further comprises a cosolvent.

In some embodiments, the phosphonothioic ester is a phosphonothioic polyisobutenyl ester. In some embodiments, the alkyl succinimide is polyisobutylene succinimide, oleyl succinimide, or hexadecyl succinimide. In some embodiments, the detergent comprises calcium phosphonate/phenate, magnesium phosphonate/phenate, calcium sulfonate, or magnesium sulfonate. In some embodiments, the asphaltene dispersant comprises an alkylphenol-formaldehyde resin, or an alkyl succinic ester. In some embodiments, the cosolvent comprises 2-butoxyethanol, and/or diethylene glycol butyl ether. In some embodiments, the antifoulant composition further comprises a non-ionic surfactant, or a film forming surfactant.

In yet another aspect of the disclosed technology, an antifoulant composition for inhibiting fouling comprises a non-ionic surfactant, and/or a film forming surfactant. In some embodiments, the composition further comprises an alkyl succinimide, a detergent, and/or an asphaltene dispersant. In some embodiments, the composition further comprises a cosolvent.

In some embodiments, the non-ionic surfactant is an alcohol ethoxylate. In some embodiments, the film forming surfactant is an imidazoline, quaternary ammonium, fatty tetrahydropyrimidine, or fatty imidazoline. In some embodiments, the fatty imidazoline is hydroxyethyl imidazoline, aminoethyl imidazoline, or polyethyleneamine imidazoline. In some embodiments, the ratio of the non-ionic surfactant to the film forming surfactant is about 1:100 to about 100:1.

In yet another aspect of the disclosed technology, an antifoulant composition comprises a phosphonothioic ester; a non-ionic surfactant; and a film forming surfactant. In some embodiments, the phosphonothioic ester is a phosphonothioic polyisobutenyl ester, the non-ionic surfactant is an alcohol ethoxylate, and the film forming surfactant is a fatty imidazoline.

In yet another aspect of the disclosed technology, a method for inhibiting fouling in a gas processing plant is provided. The method comprising (a) providing an antifoulant composition; and (b) adding the antifoulant composition to a hydrocarbon stream present in a gas processing plant.

In some embodiments of the present method, the antifoulant composition comprises a phosphonothioic ester. In some embodiments, the phosphonothioic ester is a phosphonothioic polyalkenyl ester. In some embodiments, the phosphonothioic polyalkenyl ester is a phosphonothioic polyisobutenyl ester.

In some embodiments of the present method, the antifoulant composition comprises a non-ionic surfactant and a film forming surfactant. In some embodiments, the antifoulant composition comprises a phosphonothioic ester, a non-ionic surfactant, and a film forming surfactant. In some embodiments, the non-ionic surfactant is an alcohol ethoxylate, and the film forming surfactant is a fatty imidazoline. In some embodiments of the present method, the phosphonothioic ester is a phosphonothioic polyisobutenyl ester, the non-ionic surfactant is an alcohol ethoxylate, and the film forming surfactant is a fatty imidazoline.

In some embodiments of the present method, the hydrocarbon stream comprises methane or non-methane hydrocarbons. In some embodiments, the non-methane hydrocarbons comprise C2-C5 hydrocarbon condensates.

In some embodiments, the antifoulant composition is provided to the hydrocarbon stream in an amount of about 1 ppm to about 500 ppm. In some embodiments, the antifoulant composition is provided to the hydrocarbon stream in an amount of about 10 ppm to about 50 ppm. In some embodiments, the antifoulant composition is provided to the hydrocarbon stream in an amount of about 50 ppm. In some embodiments, the antifoulant composition is provided to the hydrocarbon stream by a chemical injection method.

### BRIEF DESCRIPTION OF SEVERAL VIEWS OF THE DRAWINGS

These and other features of the disclosed technology, and the advantages, are illustrated specifically in embodiments now to be described, by way of example, with reference to the accompanying diagrammatic drawings, in which:

FIG. 1 provides results of an illustrative embodiment of the disclosed technology.

### DETAILED DESCRIPTION OF EXEMPLARY EMBODIMENTS

The disclosed technology generally provides for an antifoulant composition and method, and more specifically, an antifoulant composition and method for treating hydrocarbon streams during natural gas processing.

With the present technology, the use of the disclosed compositions and methods aid in treating the hydrocarbon streams present in a natural gas processing plant, which thereby inhibits the fouling issues that frequently occur. It is believed that the present technology provides for dispersing the organic and inorganic solids, and/or the water phase that is present in the hydrocarbon streams of gas processing plant applications in order to inhibit fouling.

In one aspect of the disclosed technology, an antifoulant composition for inhibiting fouling in a natural gas processing plant is provided. It should be understood that during natural gas processing, fouling may occur in and/or during processes such as, but not limited to, reboiling, cryogenic and/or absorption processes.

In one embodiment, the composition comprises a phosphonothioic ester. In some embodiments, wherein the phosphonothioic ester is a phosphonothioic polyalkenyl ester. In some embodiments, the phosphonothioic polyalkenyl ester is a phosphonothioic polyisobutenyl ester. In other embodiments, the phosphonothioic ester is a C₂-C₃₀ alkyl or alkenyl alcohol.

In some embodiments, the composition further comprises an alkyl succinimide, a detergent, and/or an asphaltene dispersant. In some embodiments, the composition further comprises an alkyl succinimide, a detergent, an asphaltene dispersant, or mixtures thereof.

In some embodiments, the alkyl succinimide is polyisobutylene succinimide, oleyl succinimide, or hexadecyl succinimide. In some embodiments, the alkyl succinimide is polyisobutylene succinimide, oleyl succinimide, or hexadecyl succinimide.

The detergent in the composition as described herein provides for the equipment surfaces to remain clean of any deposits and may remove deposits from fouled surfaces. In some embodiments, the detergent may include an overbased detergent. In some embodiments, the detergent comprises calcium phosphonate/phenate, magnesium phosphonate/phenate, calcium sulfonate, or magnesium sulfonate.

In some embodiments, the asphaltene dispersant comprises an alkylphenol-formaldehyde resin, or an alkyl succinic ester.

In some embodiments, the composition further comprises a cosolvent. In some embodiments, the cosolvent comprises 2-butoxyethanol, and/or diethylene glycol butyl ether.

In some embodiments, the composition further comprises a non-ionic surfactant, or a film forming surfactant.

In yet another aspect of the present technology, an antifoulant composition for inhibiting fouling in a natural gas processing plant is provided. The antifoulant composition comprises a non-ionic surfactant, and/or a film forming surfactant.

In some embodiments, the antifoulant composition further comprises an alkyl succinimide, a detergent, and/or an asphaltene dispersant. In some embodiments, the composition further comprises an alkyl succinimide, a detergent, an asphaltene dispersant, or mixtures thereof. In some embodiments, the antifoulant composition further comprises a cosolvent.

In some embodiments, the non-ionic surfactant is an alcohol ethoxylate. In other embodiments, the non-ionic surfactant may include, but is not limited to, alcohol ethoxylates, alkylphenol ethoxylates, sorbitan esters and their ethoxylates, ethoxylates-propoxylates copolymers, fatty acid ethoxylates, fatty amine ethoxylates, monoalkaolamide ethoxylates, glycol esters, glycerol/polyglycerol esters, glucosides and polyglucosides, and/or sucrose esters and their ethoxylates.

In some embodiments, the film forming surfactant is an imidazoline, quaternary ammonium, fatty tetrahydropyrimidine, or fatty imidazoline. In some embodiments, the fatty imidazoline is hydroxyethyl imidazoline, aminoethyl imidazoline, or polyethyleneamine imidazoline. In such embodiments, the fatty imidazoline aids in dispersing deposits to prevent fouling, as well as provides a film to protect the surfaces of the equipment to prevent corrosion and deposition.

In some embodiments, the ratio of the non-ionic surfactant to the film forming surfactant is about 1:100 to about 100:1. In other embodiments, the ratio of the non-ionic surfactant to the film forming surfactant is about 1:3 to about 3:1.

In a specific embodiment of the disclosed technology, an antifoulant composition for a natural gas processing plant is provided. The antifoulant composition comprises a phosphonothioic ester, a non-ionic surfactant, and a film forming surfactant. In such embodiments, the phosphonothioic ester is a phosphonothioic polyisobutenyl ester, the non-ionic surfactant is an alcohol ethoxylate, and the film forming surfactant is a fatty imidazoline.

In yet another aspect of the present technology, a method for inhibiting fouling in a natural gas processing plant is provided. The method comprises (a) providing an antifoulant composition, and (b) adding the antifoulant composition to a hydrocarbon stream present in a gas processing plant.

The method comprises providing an antifoulant composition. It should be understood that the antifoulant composition can be provided by any conventional technique. In some embodiments, the antifoulant composition is a mixture or blend.

In some embodiments, the antifoulant composition of the present method comprises a phosphonothioic ester. In some embodiments, the phosphonothioic ester is a phosphonothioic polyalkenyl ester. In some embodiments, the phosphonothioic polyalkenyl ester is a phosphonothioic polyisobutenyl ester.

In some embodiments, the antifoulant composition of the present method comprises a non-ionic surfactant and a film forming surfactant. In some embodiments, the non-ionic surfactant is an alcohol ethoxylate, and the film forming surfactant is a fatty imidazoline.

In some embodiments, the antifoulant composition of the present method comprises a phosphonothioic ester, a non-ionic surfactant, and a film forming surfactant. In some embodiments, the phosphonothioic ester is a phosphonothioic polyisobutenyl ester, the non-ionic surfactant is an alcohol ethoxylate, and the film forming surfactant is a fatty imidazoline.

The method further provides for adding the antifoulant composition to a hydrocarbon stream present in a natural gas processing plant or application. It should be understood that the antifoulant composition can be provided to the hydrocarbon stream by any conventional technique, such as, but not limited to, a chemical injection method, which may include quills, slipstream, sprayers, or the like.

In some embodiments, the hydrocarbon stream comprises methane or non-methane hydrocarbons. Such non-methane hydrocarbons are present in such gas processing equipment such as, but not limited to, three-phase separators, condensate stabilizers, deethanizer, depropanizer, debutanizer, butane splitter, and/or dehydration unit. In some embodiments, the non-methane hydrocarbons are C₂-C₅ hydrocarbon condensates. Other non-methane condensates may include, but are not limited to, H₂S, mercaptans, CO₂, napthalenes, cycloalkanes, or other aromatics.

In some embodiments, the antifoulant composition is provided to the hydrocarbon stream in an amount of about 1 ppm to about 500 ppm, in other embodiments, about 10 ppm to about 50 ppm, and in other embodiments, about 50 ppm.

### EXAMPLES

The present invention will be further described in the following examples, which should be viewed as being illustrative and should not be construed to narrow the scope of the disclosed technology or limit the scope to any particular embodiments.

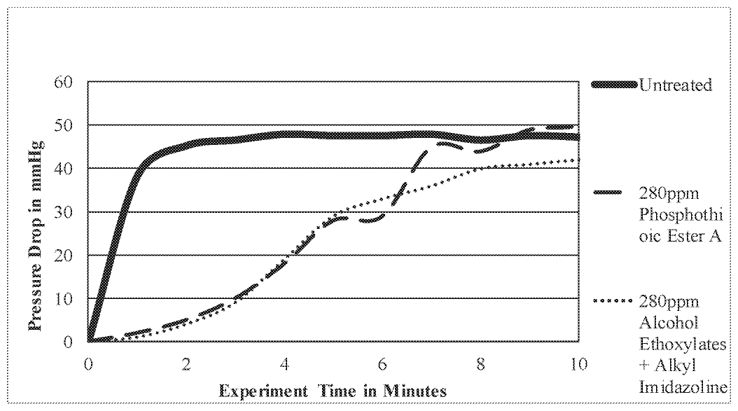

FIG. 1 provides results of the antifoulant composition performance on a stabilized condensate HLPS (hot liquid process simulator) obtained from a gas processing plant (HLPS at rod temperature 110° C.).

In the Hot Liquid Process Simulator-Differential Pressure mode (HLPS-AP), the liquid is passed over a heated rod. The heater outlet fluid pressure (before and after a filter) is monitored over the experiment duration. The system is kept under a pressurized nitrogen environment (e.g., 600 psig) and the fluid flow rate through the heated section is approximately 3.0 ml/min. The rod temperature is set at an elevated temperature (usually in a range of 100-400° C.) for untreated and treated samples to approximate process temperatures. The increase in pressure drop is measured throughout the duration of the test to characterize the fouling potential of the sample.

FIG. 1 provides the results of an untreated stream, as compared to a hydrocarbon stream treated with (1) a phosphonothioc ester treatment (at 280 ppm), and (2) an alcohol ethoxylate and alkyl imidazoline treatment (at 280 ppm).

As shown in FIG. 1, the phosphonothioc ester treatment provided about a 45% reduction in fouling, and the alcohol ethoxylate and alkyl imidazoline treatment provided about a 49% reduction in fouling. Thus, the present technology provides for a composition and method which significantly decreases fouling in natural gas processing plant applications.

In the foregoing specification, the invention has been described with reference to specific embodiments thereof. While embodiments of the disclosed technology have been described, it should be understood that the present disclosure is not so limited and modifications may be made without departing from the disclosed technology. The scope of the disclosed technology is defined by the appended claims, and all devices, processes, and methods that come within the meaning of the claims, either literally or by equivalence, are intended to be embraced therein.

1. An antifoulant composition for inhibiting fouling, the composition comprising:
a phosphonothioic ester;
a non-ionic surfactant; and
a film forming surfactant.

2. The composition as recited in claim 1, wherein the phosphonothioic ester is a phosphonothioic polyalkenyl ester.

3. The composition as recited in claim 2, wherein the phosphonothioic polyalkenyl ester is a phosphonothioic polyisobutenyl ester.

4. The composition as recited in claim 1, further comprising an alkyl succinimide, a detergent, and/or an asphaltene dispersant.

5. (canceled)

6. The composition as recited in claim 4, wherein the alkyl succinimide is polyisobutylene succinimide, oleyl succinimide, or hexadecyl succinimide; wherein the detergent comprises calcium phosphonate/phenate, magnesium phosphonate/phenate, calcium sulfonate, or magnesium sulfonate; and wherein the asphaltene dispersant comprises an alkylphenol-formaldehyde resin, or an alkyl succinic ester.

7-10. (canceled)

11. An antifoulant composition for inhibiting fouling, the composition comprising:
a non-ionic surfactant, and/or
a film forming surfactant,
wherein the ratio of the non-ionic surfactant to the film forming surfactant is about 1:100 to about 100:1.

12. The composition as recited in claim 11, wherein the non-ionic surfactant is an alcohol ethoxylate.

13. The composition as recited in claim 11, wherein the film forming surfactant is an imidazoline, quaternary ammonium, fatty tetrahydropyrimidine, or fatty imidazoline.

14. The composition as recited in claim 13, wherein the fatty imidazoline is hydroxyethyl imidazoline, aminoethyl imidazoline, or polyethyleneamine imidazoline.

15. The composition as recited in claim 11, wherein the composition further comprises an alkyl succinimide, a detergent, and/or an asphaltene dispersant.

16-18. (canceled)

19. The composition as recited in claim 1, wherein the phosphonothioic ester is a phosphonothioic polyisobutenyl ester, the non-ionic surfactant is an alcohol ethoxylate, and the film forming surfactant is a fatty imidazoline.

20. A method for inhibiting fouling in a gas processing plant, the method comprising:
(a) providing an antifoulant composition; and
(b) adding the antifoulant composition to a hydrocarbon stream present in a natural gas processing plant
wherein the antifoulant composition is provided to the hydrocarbon stream in an amount of about 1 ppm to about 500 ppm.

21. The method as recited in claim 20, wherein the antifoulant composition comprises a phosphonothioic ester.

22. The method as recited in claim 21, wherein the phosphonothioc ester is a phosphonothioic polyisobutenyl ester.

23. The method as recited in claim 20, wherein the antifoulant composition comprises (i) non-ionic surfactant and a film forming surfactant, or (ii) a phosphonothioic ester, a non-ionic surfactant, and a film forming surfactant.

24. (canceled)

25. The method as recited in claim 23, wherein the non-ionic surfactant is an alcohol ethoxylate, and the film forming surfactant is a fatty imidazoline.

26. The method as recited in claim 23, wherein the phosphonothioic ester is a phosphonothioic polyisobutenyl ester, the non-ionic surfactant is an alcohol ethoxylate, and the film forming surfactant is a fatty imidazoline.

27. The method as recited in claim 20, wherein the hydrocarbon stream comprises methane or non-methane hydrocarbons.

28. The method as recited in claim 27, wherein the non-methane hydrocarbons comprise C2-C5 hydrocarbon condensates.

29-32. (canceled)
